(19) United States
(12) Patent Application Publication
(10) Pub. No.: US 2008/0237912 A1
(43) Pub. Date: Oct. 2, 2008

(54) METHOD OF PRODUCING STAMPER FOR OPTICAL RECORDING MEDIUM, METHOD OF PRODUCING SUBSTRATE, METHOD OF PRODUCING OPTICAL RECORDING MEDIUM, AND APPARATUS FOR PRODUCING STAMPER FOR OPTICAL RECORDING MEDIUM

(75) Inventors: Yanlong Che, Odawara-shi (JP); Hiroyuki Kitamura, Odawara-shi (JP); Michihiro Shibata, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/058,627

(22) Filed: Mar. 28, 2008

(30) Foreign Application Priority Data
Mar. 29, 2007 (JP) 2007-089192

(51) Int. Cl. B29C 59/02; C25D 1/00; B23P 17/00; B23P 23/00; B23Q 7/00; B21D 31/00; B24C 1/00; G06F 19/00

(52) U.S. Cl. 264/129; 205/79; 264/293; 72/362; 29/592; 451/38; 29/559; 700/117; 29/33 R

(57) ABSTRACT

In a method of producing a stamper for roughening a substrate of an optical recording medium, a masking treatment is carried out prior to a blasting treatment, whereby a second pit forming site of a metal plate is protected such that the second pit forming site is not broken in the following blasting treatment. A mask of an adhesive sheet is attached to the second pit forming site in the masking treatment, and then a part of one major surface of the metal plate, exposed between the mask, is roughened in the blasting treatment. An original stamper of the metal plate, having a partly roughened major surface, is obtained by the blasting treatment.

### BACKGROUND OF THE INVENTION

1. Field of the Invention

The present invention relates to a method of producing a stamper for an optical recording medium, a method of producing a substrate, a method of producing an optical recording medium, and an apparatus for producing a stamper for an optical recording medium, particularly to a method of producing a stamper for an optical recording medium in order to produce an optical recording medium containing a substrate having an entirely or partly roughened major surface, a method of producing such a substrate, a method of producing such an optical recording medium, and an apparatus for producing such a stamper.

2. Description of the Related Art

In several known optical recording media such as CD-Rs and DVD-Rs, electronic information is recorded on a recording surface, and a label is attached to the reverse surface. Visible information of the contents of the electronic information, such as a song title of music data or a title of recorded data, is printed on the label, and the reverse surface is called a label surface.

Such optical recording media are produced by printing a title or the like on a circular label sheet using a printer, and by attaching the label sheet to the label surface.

Thus, the printer is needed in addition to a disc drive for producing the optical recording media. Data is recorded by the disc drive on the recording surface of the optical recording medium, the medium is removed from the disc drive, and then the label sheet printed by the printer is attached thereto. Therefore, complicated operations are required for producing the optical recording media.

Optical recording media with label surfaces, on which information can be displayed by changing the contrast using laser markers, have been proposed in Japanese Laid-Open Patent Publication No. 11-066617, etc. In the optical recording media, by using only an optical recording medium drive, information can be recorded on the recording surface and visible information can be recorded on the label surface. Thus, additional printers are not needed, and also the complicated operations of attaching the label sheet are not required.

In optical recording media such as DVD-Rs, a substrate for a recording layer may have regular grooves, and also another substrate for a visible information recording layer may have such regular grooves. In this case, the grooves on the other substrate act as a diffraction grating of external lights to cause strong interference, thereby resulting in poor visibility of recorded visible information.

The visibility can be improved by roughening the substrate. However, in this case, a light incident to the label surface is hardly scattered and the label surface has a viewing directivity. Thus, the visible information is poorly visible from one direction, though highly visible from another direction.

Accordingly, there has been a demand for further improving the visibility of visible information recorded on the label surface.

### SUMMARY OF THE INVENTION

In view of the above problem, an object of the present invention is to provide a method for producing a stamper useful for producing an optical recording medium excellent in visibility of visible information on a label surface, a stamper for an optical recording medium, a method for producing a substrate, a substrate, and an apparatus for producing a stamper for an optical recording medium.

Another object of the present invention is to provide a method for producing an optical recording medium excellent in visibility of visible information on a label surface, and an optical recording medium.

According to a first aspect of the present invention, there is provided a method of producing a stamper for an optical recording medium, comprising a pit forming step of forming a pit forming site on a part of a major surface of a metal plate, the pit forming site being used for forming a pre-pit on an optical recording medium, a masking step of placing a mask on the major surface, the mask being used for protecting the pit forming site, and a blasting step of entirely or partly roughening the major surface by a blasting treatment to produce an original stamper.

The original stamper produced by the method of the first aspect can be used for producing a stamper for an optical recording medium. Further, by using the stamper, an optical recording medium excellent in the visibility of visible information on the label surface can be produced with improved productivity.

In the first aspect, the masking step may be carried out using a mask placing apparatus comprising a base, a supporting plate, a first positioning means for positioning the supporting plate on the base, a second positioning means for positioning the metal plate on the supporting plate, and an arm that is moved at least toward the supporting plate positioned on the base with the mask held by the arm, to place the mask on the pit forming site of the metal plate positioned on the supporting plate.

In this case, the first positioning means may comprise a concave or convex portion formed on a surface of the supporting plate, the surface facing the base, and a convex or concave portion formed on the base and to be fitted to the concave or convex portion on the supporting plate, such that a center of the concave or convex portion of the supporting plate, a center of the convex or concave portion of the base, and a center of the mask held by the arm are aligned with a vertical line. The mask may be held by the arm by vacuum suction.

The second positioning means may comprise an alignment mark formed on a surface of the supporting plate, on which the metal plate is placed, an imaging device for taking a first image of the alignment mark and a second image of the pit forming site of the metal plate placed on the supporting plate, a calculating means for calculating a first center determined by the alignment mark based on the first image taken with the imaging device and calculating a second center of the pit forming site based on the second image, and a correcting means for correcting the position of the metal plate on the supporting plate such that the second center corresponds to the first center. In this case, it is preferred that the first center substantially corresponds to the center of the concave or convex portion of the supporting plate. The alignment mark may have a circular ring shape. Alternatively, three or more marks having “+” shape or the like may be arranged on a circle to form the alignment mark.

The method of the first aspect may further comprise a washing step of detaching the mask from the original stamper and then washing the original stamper, and a duplicating step of electroforming a metal layer on a surface of the original stamper, on which the pit forming site is formed, to produce a second-generation stamper comprising the metal layer. The obtained second-generation stamper may be used for producing a stamper for an optical recording medium. Further, a third, fourth, or fifth . . . stamper may be produced by using the second stamper, and may be used for producing a stamper for an optical recording medium.

According to a second aspect of the present invention, there is provided a method of producing a substrate for an optical recording medium having a visible information recording layer, on which visible information is recorded, comprising a stamper producing step of producing a stamper having an entirely or partly roughened major surface, and a substrate producing step of using the stamper to produce the substrate having an entirely or partly roughened major surface. The stamper producing step comprises a pit forming step of forming a pit forming site on a part of a major surface of a metal plate, the pit forming site being used for forming a pre-pit on an optical recording medium, a masking step of placing a mask on the major surface, the mask being used for protecting the pit forming site, and a blasting step of entirely or partly roughening the major surface by a blasting treatment to produce an original stamper.

By using the substrate produced by the method of the second aspect, an optical recording medium excellent in the visibility of visible information on the label surface can be produced with improved productivity.

According to a third aspect of the present invention, there is provided a method of producing an optical recording medium having a substrate and a visible information recording layer formed thereon, on which visible information is recorded, comprising a stamper producing step of producing a stamper having an entirely or partly roughened major surface, a substrate producing step of using the stamper to produce the substrate having an entirely or partly roughened major surface, and a visible information recording layer forming step of forming the visible information recording layer on the substrate. The stamper producing step comprises a pit forming step of forming a pit forming site on a part of a major surface of a metal plate, the pit forming site being used for forming a pre-pit on the optical recording medium, a masking step of placing a mask on the major surface, the mask being used for protecting the pit forming site, and a blasting step of entirely or partly roughening the major surface by a blasting treatment to produce an original stamper.

By using the method of the third aspect, an optical recording medium excellent in the visibility of visible information on the label surface can be produced with improved productivity.

According to a fourth aspect of the present invention, there is provided an apparatus for producing a stamper for roughening a substrate of an optical recording medium, comprising a base, a supporting plate, a first positioning means for positioning the supporting plate on the base, a second positioning means for positioning a metal plate on the supporting plate, and an arm that is moved at least toward the supporting plate positioned on the base with a mask held by the arm, to place the mask on a pit forming site of the metal plate positioned on the supporting plate.

It is preferred that a major surface of a metal plate for forming a stamper is roughened by a blasting treatment to obtain an optical recording medium excellent in the visibility of visible information on the label surface. The metal plate has the pit forming site for forming a pre-pit on the optical recording medium. Thus, when the metal plate is directly subjected to the blasting treatment, the pit forming site may be partly or entirely removed by an abrasive.

By using the apparatus of the fourth aspect for producing a stamper for an optical recording medium, the mask can be placed on the pit forming site of the metal plate with high accuracy, to protect the pit forming site. Therefore, the problem of the pit forming site removal by the blasting treatment can be solved.

In the fourth aspect, the first positioning means may comprise a concave or convex portion formed on a surface of the supporting plate, the surface facing the base, and a convex or concave portion formed on the base and to be fitted to the concave or convex portion on the supporting plate, such that a center of the concave or convex portion of the supporting plate, a center of the convex or concave portion of the base, and a center of the mask held by the arm are aligned with a vertical line.

In the fourth aspect, the mask may be held by the arm by vacuum suction.

Further, in the fourth aspect, the second positioning means may comprise an alignment mark formed on a surface of the supporting plate, on which the metal plate is placed, an imaging device for taking a first image of the alignment mark and a second image of the pit forming site of the metal plate placed on the supporting plate, a calculating means for calculating a first center determined by the alignment mark based on the first image taken with the imaging device and calculating a second center of the pit forming site based on the second image, and a correcting means for correcting the position of the metal plate on the supporting plate such that the center of the pit forming site corresponds to the center of the alignment mark. In this case, it is preferred that the second center substantially corresponds to the center of the concave or convex portion of the supporting plate. The alignment mark may have a circular ring shape. Alternatively, three or more marks having “+” shape or the like may be arranged on a circle to form the alignment mark.

As described above, by using the method of producing a stamper for an optical recording medium, the method of producing a substrate, and the apparatus for producing a stamper for an optical recording medium, according to the present invention, an optical recording medium excellent in the visibility of visible information on the label surface can be produced with improved productivity.

Further, by using the method of producing an optical recording medium according to the present invention, an optical recording medium excellent in the visibility of visible information on the label surface can be produced.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a cross-sectional view partly showing an optical recording medium according to an embodiment of the present invention;

FIG. 2 is a plan view showing an optical recording medium of a modification example according to the embodiment;

FIG. 3 is an enlarged cross-sectional view showing a pre-pit region of the optical recording medium of FIG. 1;

FIG. 4 is a cross-sectional view partly showing a master stamper according to the embodiment;

FIG. 5 is a production process chart of a method according to the embodiment;

FIG. 6A is a cross-sectional view showing an original metal plate used in the method according to the embodiment;

FIG. 6B is an enlarged cross-sectional view showing a portion of the original metal plate;

FIG. 7A is a cross-sectional view showing a conductive ring placed on the original metal plate and pressed by a pressing jig against the original metal plate;

FIG. 7B is a cross-sectional view showing a metal layer formed by Ni electroforming on a portion of the inner surface of the conductive ring and a portion of the major surface of the original metal plate;

FIG. 8 is a cross-sectional view showing a mask placed on a second pit forming site of a metal plate;

FIG. 9 is a structural view showing a mask placing apparatus according to the embodiment;

FIG. 10 is a structural view showing a second positioning means of the mask placing apparatus according to the embodiment;

FIG. 11 is a cross-sectional view showing a blasting treatment of the metal plate having the second pit forming site protected by the mask;

FIG. 12 is an enlarged cross-sectional view showing the blasting treatment of FIG. 11;

FIG. 13 is a cross-sectional view showing a washing treatment of an original stamper from which the mask has been detached;

FIG. 14 is a cross-sectional view showing a second metal layer formed on a major surface of the original stamper by Ni electroforming;

FIG. 15A is a cross-sectional view showing a metal second-generation stamper obtained by detaching the second metal layer from the major surface of the original stamper;

FIG. 15B is an enlarged cross-sectional view showing the second-generation stamper;

FIG. 16 is a cross-sectional view showing a third-generation stamper produced using the second-generation stamper by Ni electroforming; and

FIG. 17 is a cross-sectional view showing a fourth-generation stamper produced using the third-generation stamper by Ni electroforming.

### DESCRIPTION OF THE PREFERRED EMBODIMENTS

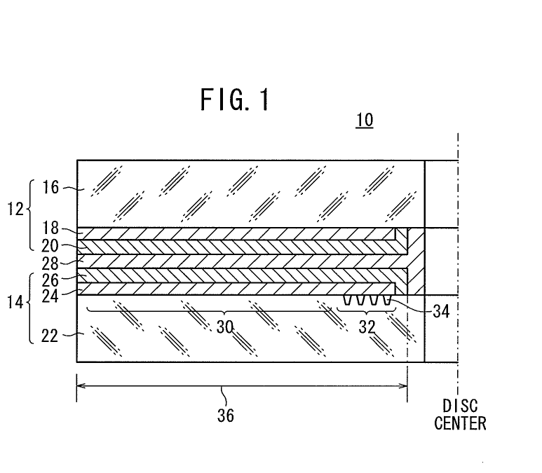

An embodiment of the method of producing a stamper for an optical recording medium, the method of producing a substrate, the method of producing an optical recording medium, and the apparatus for producing a stamper for an optical recording medium according to the present invention will be described below with reference to FIGS. 1 to 17.

An optical recording medium 10 according to this embodiment is such that information can be recorded thereon by irradiating one surface with a laser light, and desired visible information can be recorded thereon by irradiating the other surface with the laser light. Thus, in this optical recording medium, at least a data recording layer and a visible information recording layer are formed in this order on a first substrate, and a second substrate is placed on the visible information recording layer. A third substrate may be disposed between the data recording layer and the visible information recording layer.

In the optical recording medium, a surface of the second substrate facing the visible information recording layer is partly roughened. The roughened portion of the surface of the second substrate may be referred to as “the roughened substrate surface” in the following description. The roughened substrate surface is formed by transferring a roughened pattern formed on a stamper for an optical recording medium, onto the surface of the second substrate as hereinafter described.

The optical recording medium may have a structure of a DVD such as a DVD-R or an HD-DVD. The structure is such a bonded structure that the first substrate having the data recording layer is attached to the second substrate having the visible information recording layer by an adhesion layer.

Further, the optical recording medium of the embodiment may have a structure of Blu-ray Disc (BD).

A specific structure example of the optical recording medium 10 according to this embodiment will be described below with reference to FIGS. 1 to 3.

The optical recording medium 10 shown in FIG. 1 has a first stack 12 and a second stack 14. The first stack 12 contains a transparent first substrate 16, a data recording layer 18 formed on the first substrate 16, and a first reflective layer 20 formed on the data recording layer 18. The second stack 14 contains a transparent second substrate 22, a visible information recording layer 24 formed on the second substrate 22, and a second reflective layer 26 formed on the visible information recording layer 24. The first stack 12 is attached to the second stack 14 by an adhesion layer 28 such that the first reflective layer 20 faces the second reflective layer 26.

For example, data (pit information) can be recorded on and/or reproduced from the data recording layer 18 by irradiating the layer with a laser light through the first substrate 16.

For example, visible information can be recorded on the visible information recording layer 24 by irradiating the layer with a laser light through the second substrate 22.

In the optical recording medium 10, a roughened substrate surface 30 is formed on a portion of the surface of the second substrate 22 facing the visible information recording layer 24. The surface roughness of the roughened substrate surface 30 of the second substrate 22 is preferably such that the center line average roughness Ra is 0.05 to 0.3 μm and the ten-point average roughness Rz is 0.1 to 5 μm. The image visibility of the optical recording medium 10 can be largely improved when the roughened substrate surface 30 has such a surface roughness. The values of Ra and Rz of the roughened substrate surface 30 on the second substrate 22 can be measured by an atomic force microscope (AFM), an optical interference-type roughness meter, a stylus-type roughness meter, or the like. The stylus-type roughness meter is particularly preferred because it has a long scanning length and a large dynamic range in the depth direction. Thus, the values of Ra and Rz are obtained by the stylus-type roughness meter in the present invention, unless otherwise noted.

The roughened substrate surface 30 may be formed over the entire surface of the second substrate 22. The roughened substrate surface 30 is formed preferably in a region of 20 to 60 mm, more preferably in a region of 24 to 58 mm, from the center of the medium. When the roughened substrate surface 30 is formed in a region of less than 20 mm from the center, the visibility is seldom improved by the roughened substrate surface 30 because an optical pickup is hardly placed in the region. On the other hand, when the roughened substrate surface 30 is formed in a region of more than 58 mm from the center, it becomes difficult to wash the edge of the visible information recording layer 24.

In the optical recording medium 10, there is a pre-pit region 32 on a portion of the surface of the second substrate 22 (the surface on which the visible information recording layer 24 is formed). One or more pre-pits 34, preferably a plurality of pre-pits 34, are formed in the pre-pit region 32.

The combination of the pre-pits 34 may provide various information of the optical recording medium 10 such as information for distinguishing the presence of the visible information recording layer 24, information of an output or a spot diameter of a laser light for forming visible information on the visible information recording layer 24, or information of tone of visible information.

Thus, by detecting the pre-pits 34, the presence of the visible information recording layer 24 in the optical recording medium 10 can be easily detected, and visible information can be recorded on the visible information recording layer 24 under an optimum laser output with excellent imaging properties. Further, the combination of the pre-pits 34 may provide manufacturer information.

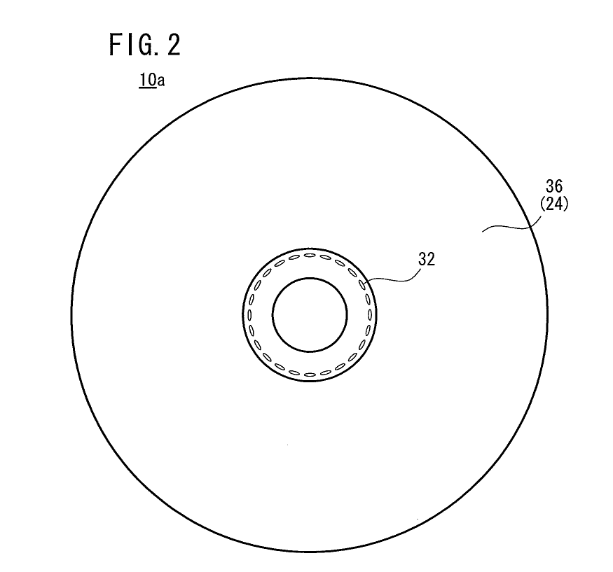

The position of the pre-pit region 32 on the second substrate 22 is not particularly limited. For example, as shown in FIG. 2, the pre-pit region 32 may be formed inside a region having the visible information recording layer 24 (an imaging region 36) in an optical recording medium 10a of a modification example. In this case, the pre-pits 34 are not filled with a dye compound, so that a light returned from the pre-pits 34 is easily detected advantageously. It should be noted that, to prevent the visible information recording layer 24 from being formed in the pre-pit region 32, it is necessary to form a certain margin between the outer circumference of the pre-pit region 32 and the inner circumference of the imaging region 36.

As shown in FIG. 1, the pre-pit region 32 may be partly overlapped with the imaging region 36 to make the imaging region 36 as large as possible. Thus, a portion of the visible information recording layer 24 may be formed on a part of the pre-pits 34.

In the case of forming the pre-pit region 32 on an inner portion of the second substrate 22 as shown in FIGS. 1 and 2, the pre-pit region 32 is preferably in a region of 21 to 24 mm in the radius direction from the center of the second substrate 22.

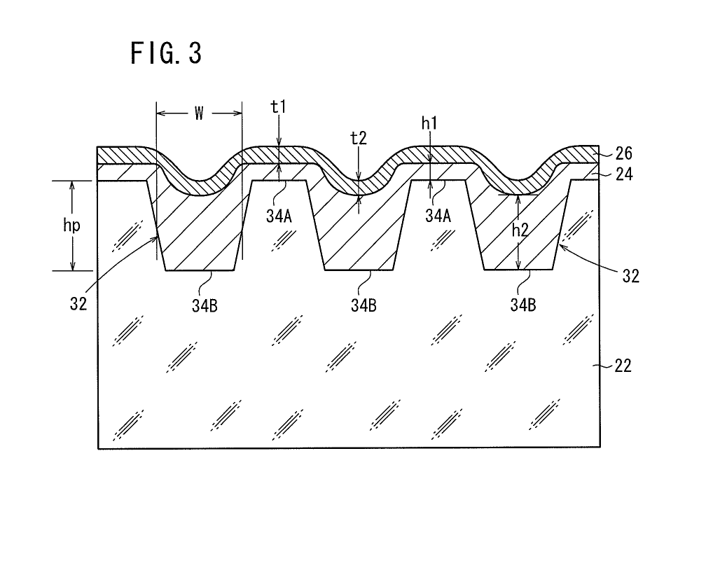

The average of the depths hp of the pre-pits 34, shown in FIG. 3, is 150 to 400 nm, preferably 200 to 300 nm. When the average depth is 150 to 400 nm, a light returned from the pre-pits 34 can be converted to an electronic signal (a returned light signal) having a large signal amplitude, whereby the accuracy of reading the returned light signal can be improved. Further, when the average depth is 200 to 300 nm, the returned light signal can be detected more accurately.

The average of the half widths W of the pre-pits 34 in the radius direction is preferably 200 to 500 nm, more preferably 250 to 450 nm. When the average width is 200 to 500 nm, the inter-track crosstalk superposed with the returned light signal is reduced, whereby a signal amplitude sufficient for detection can be obtained. The lengths (the half widths) of the pre-pits 34 in the circumferential direction are appropriately controlled depending on information to be recorded.

The ratio h1/h2, in which h1 represents an average thickness of the visible information recording layer 24 on convex portions 34A of the pre-pits 34, and h2 represents an average thickness of the visible information recording layer 24 on concave portions 34B, is preferably 0.1 to 0.9. The depth hp+h1−h2 of depression of the visible information recording layer 24 on the concave portions 34B is preferably 70 to 250 nm.

When the ratio h1/h2 and the depth hp+h1-h2 are within the above ranges, a surface of the visible information recording layer 24, on which the second reflective layer 26 is formed, has appropriate convexes and concaves suitable for reading a laser light, so that an excellent reproduced signal can be obtained. The ratio h1/h2 is more preferably 0.2 to 0.8, and the depth hp+h1−h2 is more preferably 100 to 200 nm, further preferably 120 to 180 nm.

The second reflective layer 26 is preferably formed along the visible information recording layer 24 as shown in FIG. 3. The ratio t1/t2, in which t1 represents an average thickness of the second reflective layer 26 on the convex portions 34A, and t2 represents an average thickness of the second reflective layer 26 on the concave portions 34B, is preferably 0.8 to 1.2, more preferably 0.9 to 1.1.

The above values of hp, h1, h2, etc. can be obtained by an AFM, a transmission spectrum, or an ellipsometer. Further, the values can be obtained by observing a cross-section of the produced optical recording medium 10 using an SEM, etc.

A pregroove region having pregrooves may be formed instead of the pre-pit region 32. Alternatively, a burst cutting area (BCA), on which a convexoconcave bar-code pattern is recorded, may be used instead of the pre-pit region 32. In this case, the pregrooves or the bar-code pattern may contain various information of the optical recording medium 10 such as information for distinguishing the presence of the visible information recording layer 24, information of output (e.g., laser power) or a spot diameter of a laser light for forming a visible information on the visible information recording layer 24, or information of tone of visible information.

### Stamper and Method of Producing the Same:

The above second substrate 22, which has the pre-pits 34 and the roughened substrate surface 30 on a portion of the surface, can be produced by using a master stamper 40 according to the present embodiment.

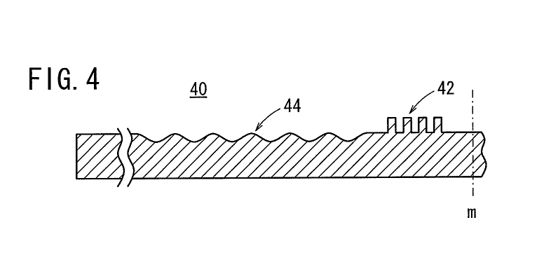

As shown in FIG. 4, in the master stamper 40, a pit forming site 42 for forming the pre-pits 34 on the inner surface of the second substrate 22 is formed in a portion of a major surface, and a roughened stamper surface 44 for forming the roughened substrate surface 30 on a portion of the surface of the second substrate 22 is formed in a portion of the major surface. The pit forming site 42 contains concave portions and convex portions, and the average height of the convex portions is preferably 150 to 400 nm. The optical recording medium 10 can be efficiently produced by using the master stamper 40.

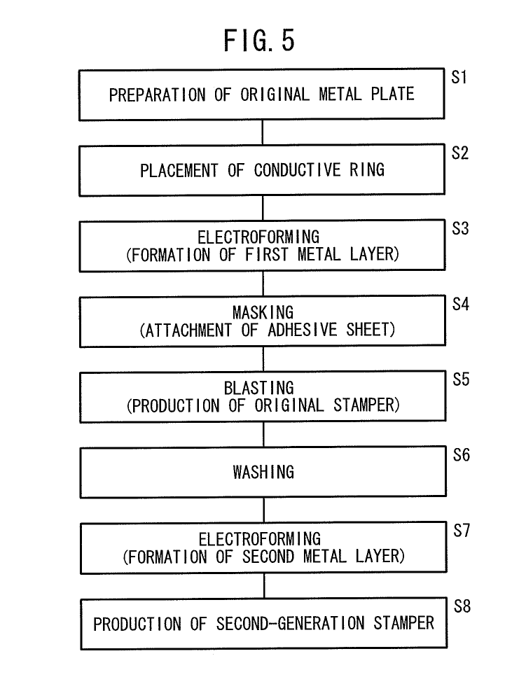

A method of producing the master stamper 40 will be described below with reference to FIGS. 5 to 17.

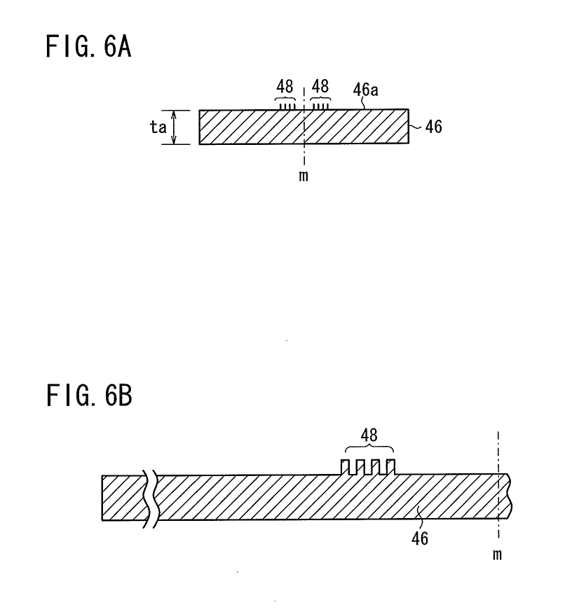

First, an original metal plate 46 is prepared as shown in the step S1 of FIG. 5, and FIGS. 6A and 6B. A first pit forming site 48 for forming the pit forming site 42 on the master stamper 40 is formed on a flat major surface 46a of the original metal plate 46. The original metal plate 46 is a Ni disc produced by Ni (nickel) electroforming. The enlarged view of FIG. 6B illustrates only an area near the center line m, as with the other enlarged views to be hereinafter described.

The thickness ta of the original metal plate 46 may be approximately 300 μm, which is a usual thickness for producing the master stamper 40. The thickness ta may be 140 to 160 μm, and in this case, the time required for the Ni electroforming for producing the original metal plate 46 can be reduced, resulting in a high productivity. In addition to the above Ni, Cu (copper), Al (aluminum), Ni alloys, Cu alloys, Al alloys, etc. may be used for the original metal plate 46.

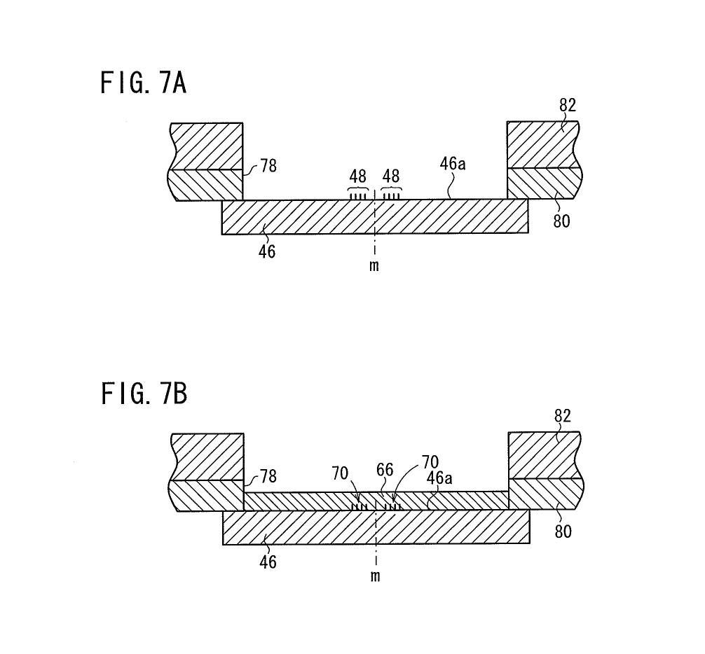

Then, as shown in step S2 of FIG. 5, and FIGS. 7A and 7B, a conductive ring 80 having a hole 78 at the center is placed on the major surface 46a of the original metal plate 46. The conductive ring 80 is, for example, composed of a stainless steel.

Then, the electroforming step S3 of FIG. 5 is carried out. As shown in FIG. 7A, a pressing jig 82 for pressing the conductive ring 80 against the original metal plate 46, which has a hole at the center, is used in the electroforming. As shown in FIG. 7B, a portion of the major surface 46a exposed in the hole 78 of the conductive ring 80, and a portion of the inner wall surface of the conductive ring 80 are covered with a first metal layer 66 by the Ni electroforming.

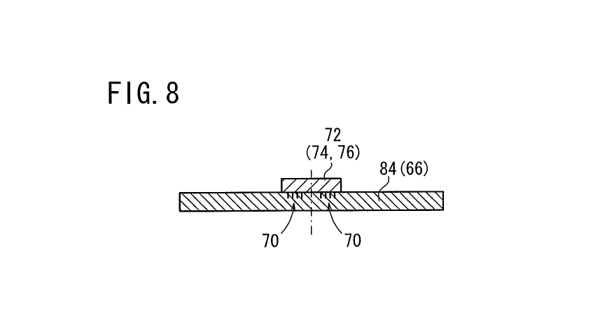

Then, the masking step S4 of FIG. 5 is carried out. In the masking process, as shown in FIG. 8, the original metal plate 46 is detached from the first metal layer 66. The first metal layer 66 is used as a metal plate 84, and the first pit forming site 48 of the original metal plate 46 is transferred onto the metal plate 84 to form a second pit forming site 70. The second pit forming site 70 is protected by the masking to prevent the second pit forming site 70 from being broken in the following blasting treatment. The masking may be achieved by placing a metal mask 72, by attaching a mask 74 of an adhesive sheet, or by forming a mask 76 of an oxide film or the like. In this embodiment, the mask 74 formed by attaching the adhesive sheet is used.

When the mask 74 is attached to the second pit forming site 70 of the metal plate 84, the mask 74 may be positioned and attached based on the center position of the metal plate 84. However, in some cases, the center position of the metal plate 84 does not correspond to the center position of the second pit forming site 70 in some cases due to a position error of the first pit forming site 48 on the original metal plate 46 (see FIG. 6A), an installation error of the conductive ring 80 to the original metal plate 46, etc.

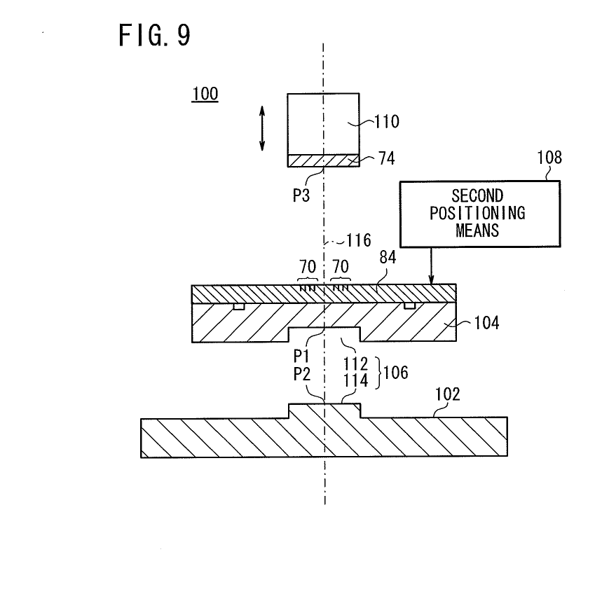

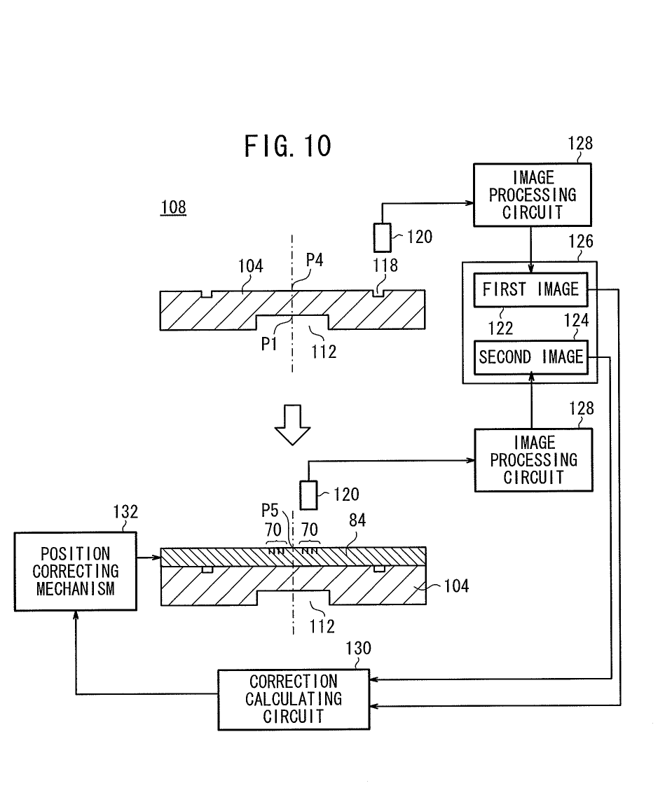

Thus, in this embodiment, the mask 74 is attached to the metal plate 84 using a mask placing apparatus 100, capable of positioning the mask 74 on the second pit forming site 70 with high accuracy. The mask placing apparatus 100 will be described below with reference to FIGS. 9 and 10.

As shown in FIG. 9, the mask placing apparatus 100 has a base 102, an supporting plate 104, a first positioning means 106 for positioning the supporting plate 104 on the base 102, a second positioning means 108 for positioning the metal plate 84 on the supporting plate 104, and an arm 110 that is moved at least toward the supporting plate 104 positioned on the base 102 with the mask 74 held by the arm 110, to place the mask 74 (to attach the adhesive sheet) onto the second pit forming site 70 of the metal plate 84 positioned on the supporting plate 104. For example, the mask 74 may be held by the arm 110 by vacuum suction.

The first positioning means 106 contains a concave portion 112 formed in a surface of the supporting plate 104, i.e., in the surface facing the base 102, and a convex portion 114 formed on the base 102 to be inserted into the concave portion 112 in the supporting plate 104. A center P1 of the concave portion 112 of the supporting plate 104, a center P2 of the convex portion 114 of the base 102, and a center P3 of the mask 74 held by the arm 110 are aligned with a vertical line 116.

Though the first positioning means 106 of the above example is such that the concave portion 112 is formed on the supporting plate 104 and the convex portion 114 is formed on the base 102, the first positioning means 106 may be such that a convex portion is formed on the supporting plate 104 and a concave portion is formed on the base 102 (not shown).

As shown in FIG. 10, the second positioning means 108 includes an alignment mark 118 formed on a surface of the supporting plate 104, on which the metal plate 84 is placed, an imaging device 120 for taking an image of the alignment mark 118 (a first image 122) and then taking an image of the second pit forming site 70 of the metal plate 84 placed on the supporting plate 104 (a second image 124), an image processing circuit 128 for processing image data from the imaging device 120 and recording the first image 122 of the alignment mark 118 and the second image 124 of the second pit forming site 70 on a memory 126, a correction calculating circuit 130 for calculating a first center P4 determined by the alignment mark 118 based on the first image 122 recorded on the memory 126 and calculating a second center P5 of the second pit forming site 70 based on the second image 124, and a position correcting mechanism 132 for correcting the position of the metal plate 84 on the supporting plate 104 such that the second center P5 corresponds to the first center P4. Though two imaging devices 120 and two image processing circuits 128 are shown in FIG. 10 for convenience of explanation, the second positioning means 108 practically contains one imaging device 120 and one image processing circuit 128. The alignment mark 118 may have a circular ring shape. Alternatively, three or more marks having “+” shape or the like may be arranged on a circle to form the alignment mark 118.

In this embodiment, the first center P4 determined by the alignment mark 118 approximately corresponds to the center P1 of the concave portion 112. Thus, the metal plate 84 is positioned on the supporting plate 104 by the second positioning means 108 such that the first center P4 corresponds to the second center P5 of the second pit forming site 70 on the metal plate 84, and the center P1 of the concave portion 112 on the supporting plate 104, the center P2 of the convex portion 114 on the base 102, and the center P3 of the mask 74 held by the arm 110 are aligned with the vertical line 116 by the first positioning means 106 as described above, so that the center P3 of the mask 74 and the center P5 of the second pit forming site 70 on the metal plate 84 are aligned with the vertical line 116. As a result, the mask 74 can be placed on the second pit forming site 70 with high accuracy by moving the arm 110 toward the supporting plate 104 to attach the mask 74 onto the metal plate 84. The arm 110 is preferably moved toward or away from the supporting plate 104 by supplying compressed air to a cylinder (not shown) or by discharging compressed air from the cylinder. It is preferred that a detecting means (not shown) for measuring the distance between the arm 110 and the supporting plate 104 is provided, and a servo mechanism is incorporated to control the approach speed and stop position of the arm 110 based on the measured distance. Thus, damage to the second pit forming site 70 can be reduced.

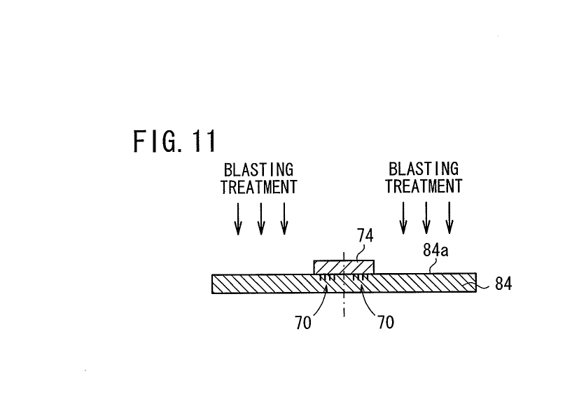

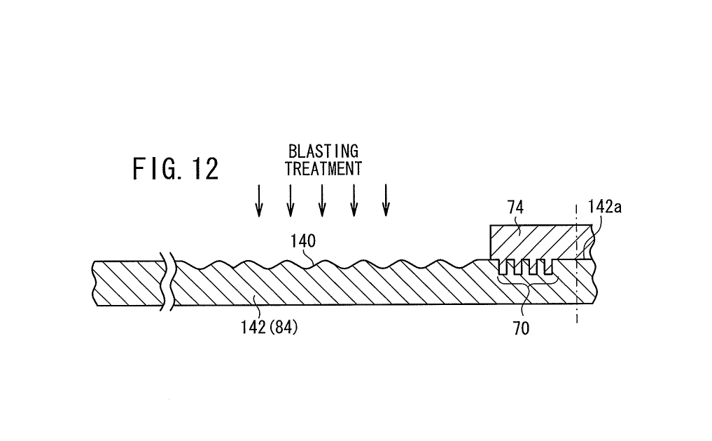

Then, the blasting step S5 of FIG. 5 is carried out. As shown in FIG. 11, a portion of an unmasked major surface 84a of the metal plate 84 is roughened by a blasting treatment. Thus, as shown in FIG. 12, a first roughened surface 140 is formed on a portion of the major surface 84a of the metal plate 84 by the blasting treatment. An original stamper 142 of the metal plate 84, having the partly roughened major surface 142a, is obtained in this step. In the blasting treatment, an abrasive material such as metal particles or non-metal particles (e.g. silica sand, emery, glass beads, resin beads, SiC particles) is sprayed onto a blasting subject surface at a high speed, to roughen the surface. In this embodiment, glass beads are used as the abrasive material.

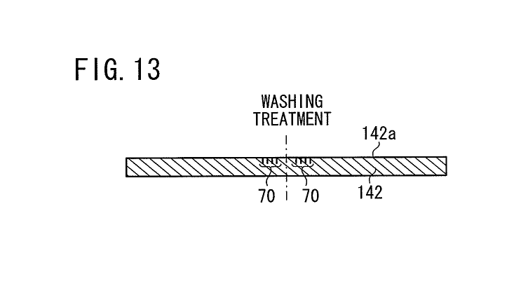

As shown in FIG. 13, the mask 74 is detached from the original stamper 142, and the original stamper 142 is washed in the step S6 of FIG. 5. For example, the original stamper 142 may be washed with ethanol, or with ultrasonic irradiation in pure water.

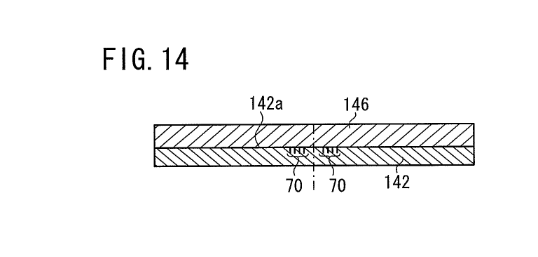

In the step S7 of FIG. 5, the original stamper 142 having the partly roughened major surface 142a is subjected to Ni electroforming. As shown in FIG. 14, a second metal layer 146 is formed on the major surface 142a of the original stamper 142 by the Ni electroforming. The second metal layer 146 formed by the Ni electroforming has a thickness of approximately 300 μm.

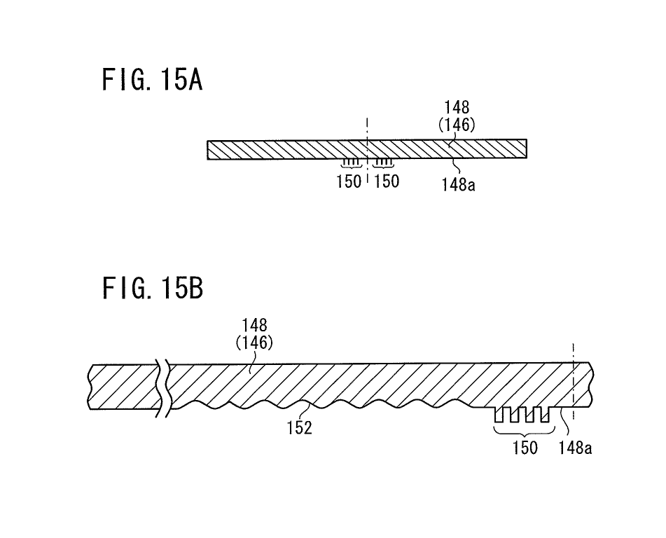

In the step S8 of FIG. 5, as shown in FIGS. 15A and 15B, the second metal layer 146 is isolated from the major surface 142a of the original stamper 142 to obtain a metal second-generation stamper 148 composed of the second metal layer 146. A third pit forming site 150 is formed on a major surface 148a of the second-generation stamper 148, and it has a transfer pattern of the second pit forming site 70 formed on the major surface 142a of the original stamper 142 (see FIG. 14). Further, a second roughened surface 152 is formed in the major surface 148a, and it has a transfer pattern of the first roughened surface 140 formed on the major surface 142a of the original stamper 142 (see FIG. 12).

A plurality of the second-generation stampers 148 can be produced using the original stamper 142 by repeating steps S7 and S8 of FIG. 5.

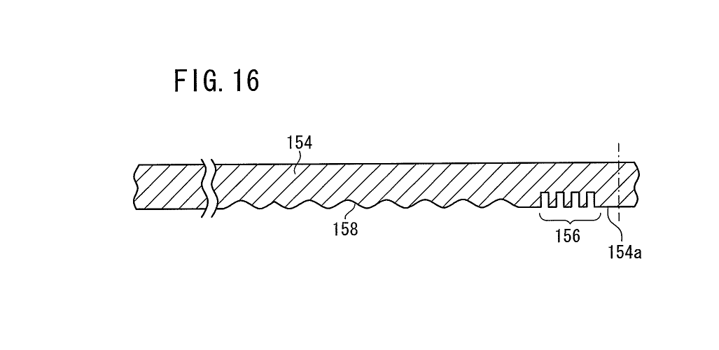

The second-generation stamper 148 may be used as the master stamper 40 for producing the second substrate 22, or a third-generation stamper 154 shown in FIG. 16 may be produced using the second-generation stamper 148 by Ni electroforming and may be used as the master stamper 40. In this case, as shown in FIG. 16, a fourth pit forming site 156 is formed on a major surface 154a of the third-generation stamper 154, and it has a transfer pattern of the third pit forming site 150 formed on the major surface 148a of the second-generation stamper 148 (see FIG. 15B). Further, a third roughened surface 158 is formed in the major surface 154a, and it has a transfer pattern of the second roughened surface 152 formed on the major surface 148a of the second-generation stamper 148.

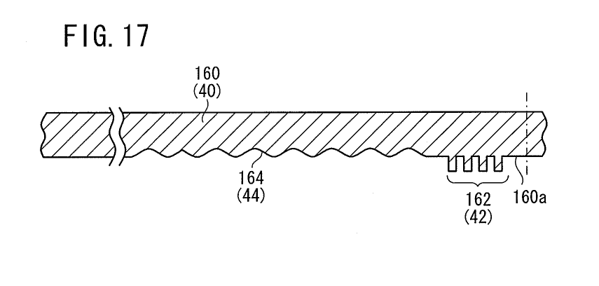

Further, a fourth-generation stamper 160 shown in FIG. 17 may be produced using the third-generation stamper 154 by Ni electroforming and may be used as the master stamper 40. In this case, a fifth pit forming site 162 is formed on a major surface 160a of the fourth-generation stamper 160, and it has a transfer pattern of the fourth pit forming site 156 on the major surface 154a of the third-generation stamper 154 (see FIG. 16). Further, a fourth roughened surface 164 is formed in the major surface 160a, and it has a transfer pattern of the third roughened surface 158 formed in the major surface 154a of the third-generation stamper 154.

An example of the fourth-generation stamper 160 used as the master stamper 40 is shown in FIG. 4. Thus, the fifth pit forming site 162 of FIG. 17 corresponds to the pit forming site 42 of FIG. 4, and the fourth roughened surface 164 of FIG. 17 corresponds to the roughened stamper surface 44 of FIG. 4.

The third-generation stamper 154 and the fourth-generation stamper 160 can be repeatedly produced by the Ni electroforming using the second-generation stamper 148 and the third-generation stamper 154 respectively. Thus, a large number of the master stampers 40 can be more easily produced with lower production costs and higher productivity in the case of using the third-generation or fourth-generation stampers, as compared with the case of using the second-generation stamper 148 as the master stamper 40.

As described above, in this embodiment, a portion of the major surface 84a of the metal plate 84 is roughened by the blasting treatment to produce the original stamper 142 having the first roughened surface 140, and any one of the second-generation stamper 148, the third-generation stamper 154, and the fourth-generation stamper 160, having the transfer pattern of the first roughened surface 140, can be used as the master stamper 40. Therefore, an incident light is easily scattered on the roughened substrate surface 30 of the second substrate 22 produced by using the master stamper 40, whereby visible information formed thereon is visible from any direction. Thus, the resultant optical recording medium 10 has an excellent visibility of the visible information on the label surface.

The surface roughness of the roughened stamper surface 44 of the master stamper 40 is preferably such that the center line average roughness Ra is 0.05 to 0.3 μm and the ten-point average roughness Rz is 0.1 to 5 μm.

The structure of the optical recording medium 10 is not particularly limited as long as it contains the pre-pit region 32 with the one or more pre-pits 34 and the visible information recording layer 24 on which visible information can be formed by irradiation of a laser light. Thus, the optical recording medium 10 may be a read-only-, WORM (Write Once, Read Many)-, or rewritable-type medium, and is preferably a WORM-type medium. The recording manner of the optical recording medium 10 may be selected from phase change-, magnetic optical-, and dye-type recording manners without particular restrictions, and is preferably dye-type.

The optical recording medium 10 shown in FIG. 1 is such that the data recording layer 18 on the first substrate 16 is attached to the visible information recording layer 24 on the second substrate 22. Thus, the optical recording medium 10 is preferably used for DVDs, such as DVD-Rs, DVD-RWs, and HD-DVDs.

Examples of the layer structure of the optical recording medium 10 include the following first to sixth unillustrated layer structures in addition to the above structure shown in FIG. 1.

(1) The first layer structure is such that the data recording layer 18, the first reflective layer 20, and the adhesion layer 28 are formed in this order on the first substrate 16, and the second substrate 22 having the visible information recording layer 24 is attached to the adhesion layer 28.

(2) The second layer structure is such that the data recording layer 18, the first reflective layer 20, a protective layer, and the adhesion layer 28 are formed in this order on the first substrate 16, and the second substrate 22 having the visible information recording layer 24 is attached to the adhesion layer 28.

(3) The third layer structure is such that the data recording layer 18, the first reflective layer 20, a first protective layer, the adhesion layer 28, and a second protective layer are formed in this order on the first substrate 16, and the second substrate 22 having the visible information recording layer 24 is attached to the second protective layer.

(4) The fourth layer structure is such that the data recording layer 18, the first reflective layer 20, a first protective layer, the adhesion layer 28, a second protective layer, and a third protective layer are formed in this order on the first substrate 16, and the second substrate 22 having the visible information recording layer 24 is attached to the third protective layer.

(5) The fifth layer structure is substantially equal to the structure of FIG. 1, and is such that the data recording layer 18, the first reflective layer 20, the adhesion layer 28, and the second reflective layer 26 are formed in this order on the first substrate 16, and the second substrate 22 having the visible information recording layer 24 is attached to the second reflective layer 26.

(6) The sixth layer structure is such that the data recording layer 18, the first reflective layer 20, and a first protective layer are formed in this order on the first substrate 16, the visible information recording layer 24, the second reflective layer 26, and a second protective layer are formed in this order on the second substrate 22, and the first protective layer is attached to the second protective layer by the adhesion layer 28.

The layer structure of FIG. 1 and the first to sixth layer structures are considered in all respects to be illustrative and not restrictive, and the above layers may be formed in another order and the layers other than the visible information recording layer 24 may be removed. Further, each of the layers may have a single- or multi-layer structure.

When optical information is recorded on or reproduced from the optical recording medium 10, the first substrate 16 side of the optical recording medium 10 is irradiated with a laser light having a predetermined wavelength, which may be 650 to 670 nm for DVD-Rs and 400 to 410 nm for HD-DVDs.

When visible information is recorded on the visible information recording layer 24, the second substrate 22 side of the optical recording medium 10 is irradiated with a laser light (such as a laser light having a linear speed of 3.5 m/s, a wavelength of 660 nm, an NA value of 0.6, and a medium surface power of 10 mW), and the irradiated portions are degenerated to change the contrast, thereby forming visible information.

In the present invention, the desired visible information can be efficiently recorded on the label surface (the visible information recording surface) of the optical recording medium 10 by the laser light using an optical recording medium drive without a printer or the like. Further, the surface of the second substrate 22, facing the visible information recording layer 24, is roughened, whereby the visibility of the visible information can be improved.

In this embodiment, the first substrate 16 is disposed on one side of the data recording layer 18, etc., and the second substrate 22 is disposed on the other side. The second substrate 22 may have a cover layer, a transparent sheet, or the like. Thus, the optical recording medium 10 of this embodiment may have a structure of CDs such as CD-Rs, in which an data recording layer, an visible information recording layer, and a cover layer are formed in this order on a substrate.

In the CD-type structure, the data recording layer 18, the first reflective layer 20, a protective layer, the second reflective layer 26, and the visible information recording layer 24 are formed in this order on the first substrate 16, and a roughened cover layer is formed on the visible information recording layer 24. In this structure, the surface of the cover layer, facing the visible information recording layer 24, is roughened, whereby the visibility of the visible information can be improved.

In this case, when optical information is recorded on or reproduced from the CD-type optical recording medium 10, the first substrate 16 side of the optical recording medium 10 is irradiated with a laser light having a predetermined wavelength of 660 nm, etc.

When visible information is recorded on the visible information recording layer 24, the cover layer side (the second substrate 22 side) of the CD-type optical recording medium 10 is irradiated with a laser light, and the irradiated portions are degenerated to change the contrast for forming visible information.

Thus, even when the optical recording medium has the CD-type structure, visible information can be formed thereon by a laser light. The desired visible information can be efficiently recorded on the label surface (the visible information recording surface) of the optical recording medium 10 by using an optical recording medium drive without a printer or the like. Further, the surface of the second substrate 22, facing the visible information recording layer 24, is roughened, whereby the visibility of the visible information can be improved.

The optical recording medium 10 having the DVD-type structure shown in FIG. 1 may be produced in the following manner. Thus, for example, the master stamper 40 having the roughened stamper surface 44 on one major surface is prepared, the second substrate 22 having the roughened substrate surface 30 on one major surface is prepared using the master stamper 40, the visible information recording layer 24 is formed on the second substrate 22, the data recording layer 18 is formed on the first substrate 16, and the first substrate 16 and the second substrate 22 are bonded such that the data recording layer 18 and the visible information recording layer 24 face each other, whereby the optical recording medium 10 can be produced.

A reflective layer or a protective layer may be formed in the step of forming the data recording layer and the step of forming the visible information recording layer if necessary.

The optical recording medium having the CD-type structure can be produced by forming at least the data recording layer 18, the visible information recording layer 24, and the cover layer (the second substrate 22) having a roughened surface on the first substrate 16.

The layer structure of FIG. 1 and the first to sixth layer structures are considered in all respects to be illustrative and not restrictive, and the above layers may be formed in another order and the layers other than the visible information recording layer 24 may be removed. Further, each of the layers may have a single- or multi-layer structure.

The layers and forming methods thereof will be described below with reference to the layer structure of the optical recording medium 10 shown in FIG. 1.

### (Data Recording Layer 18)

The data recording layer 18 is a layer on which information, particularly code information such as digital information, is recorded and reproduced by a laser light. The data recording layer 18 may be a dye recording layer or a phase change recording layer, and is preferably a dye recording layer.

Examples of dyes used in the data recording layer 18 include cyanine dyes, oxonol dyes, azo dyes, phthalocyanine dyes, triazole compounds such as benzotriazole compounds, triazine compounds, merocyanine compounds, aminobutadiene compounds, cinnamic acid compounds, benzoxazole compounds, pyrromethene compounds, and squarylium compounds. The dyes may have a metal atom as a coordination center.

Dyes described in Japanese Laid-Open Patent Publication Nos. 4-074690, 8-127174, 11-053758, 11-334204, 11-334205, 11-334206, 11-334207, 2000-043423, 2000-108513, and 2000-158818, etc. may be used in the present invention.

When the optical recording medium is CD-R, preferred ones among the above are the cyanine dyes, azo dyes, and phthalocyanine dyes. When the optical recording medium is a DVD-R, preferred ones are the cyanine dyes, oxonol dyes, azo dyes (including Ni complexes and Co complexes), and pyrromethene compounds. When the optical recording medium is a Blu-ray disc or an HD-DVD, preferred ones are the cyanine dyes, oxonol dyes, azo dyes, phthalocyanine dyes, benzotriazole compounds, and triazine compounds.

Further, the cyanine dyes, azo dyes, and phthalocyanine dyes are more preferred in the case of the CD-R, the cyanine dyes, oxonol dyes, and azo dyes (including Ni complexes and Co complexes) are more preferred in the case of the DVD-R, and the cyanine dyes, oxonol dyes, azo dyes, and phthalocyanine dyes are more preferred in the case of the Blu-ray disc or HD-DVD.

The data recording layer 18 may be formed by the steps of dissolving a binder, etc. and a recording substance such as the dye in an appropriate solvent to prepare a coating liquid, applying the coating liquid to the first substrate 16, and drying the applied liquid. The concentration of the recording substance in the coating liquid is generally 0.01% to 15% by mass, preferably 0.1% to 10% by mass, more preferably 0.5% to 5% by mass, most preferably 0.5% to 3% by mass.

The data recording layer 18 may be formed by vapor deposition, sputtering, CVD, or liquid coating, and is preferably formed by liquid coating. In the case of the liquid coating, a quencher, a binder, or the like is dissolved in the solvent together with the dye, etc. if necessary, and the obtained coating liquid is applied to the substrate and dried.

Examples of the solvents for the coating liquid include esters such as butyl acetate, ethyl lactate, and 2-methoxyethyl acetate; ketones such as methyl ethyl ketone, cyclohexanone, and methyl isobutyl ketone; chlorinated hydrocarbons such as dichloromethane, 1,2-dichloroethane, and chloroform; amides such as dimethylformamide; hydrocarbons such as methylcyclohexane; ethers such as dibutyl ether, diethyl ether, tetrahydrofuran, and dioxane; alcohols such as ethanol, n-propanol, isopropanol, n-butanol, and diacetone alcohol; fluorine-containing solvents such as 2,2,3,3-tetrafluoropropanol; and glycol ethers such as ethylene glycol monomethyl ether, ethylene glycol monoethyl ether, and propylene glycol monomethyl ether.

These solvents may be used singly or in combination depending on the solubility of the dye. Various additives such as antioxidants, UV absorbers, plasticizers, and lubricants may be added to the coating liquid if necessary.

Examples of the binders include natural organic high-molecular substances such as gelatins, cellulose derivatives, dextrans, rosins, and rubbers, and synthetic organic high-molecular substances. The synthetic organic high-molecular substances include hydrocarbon resins such as polyethylenes, polypropylenes, polystyrenes, and polyisobutylenes; vinyl resins such as polyvinyl chlorides, polyvinylidene chlorides, and vinyl chloride-vinyl acetate copolymers; acrylic resins such as polymethyl acrylates and polymethyl methacrylates; and initial condensation products of thermosetting resins such as polyvinyl alcohols, chlorinated polyethylenes, epoxy resins, butyral resins, rubber derivatives, and phenol-formaldehyde resins.

In the case of using the binder in the data recording layer 18, the mass of the binder is generally 0.01 to 50 times the dye, preferably 0.1 to 5 times the dye.

The coating liquid may be applied by a spraying method, a spin coating method, a dipping method, a roll coating method, a blade coating method, a doctor roll method, a screen printing method, etc. The data recording layer may have a single- or multi-layer structure. The thickness of the data recording layer is generally 10 to 500 nm, preferably 15 to 300 nm, more preferably 20 to 150 nm.

An anti-fading agent may be added to the data recording layer 18 to increase the lightfastness. In general, the anti-fading agent is a singlet oxygen quencher. The singlet oxygen quencher may be selected from those described in known publications such as patent publications. Specific examples of the singlet oxygen quenchers include those described in Japanese Laid-Open Patent Publication Nos. 58-175693, 59-031194, 60-018387, 60-019586, 60-019587, 60-035054, 60-036190, 60-036191, 60-044554, 60-044555, 60-044389, 60-044390, 60-054892, 60-047069, 63-209995, and 4-025492, Japanese Patent Publication Nos. 1-038680 and 6-026028, Germany Patent No. 350399, Nippon Kagakukaishi, 1992, October issue, Page 1141, etc.

The ratio of the anti-fading agent such as the singlet oxygen quencher to the dye is generally 0.1% to 50% by mass, preferably 0.5% to 45% by mass, further preferably 3% to 40% by mass, particularly preferably 5% to 25% by mass.

In a case where the data recording layer 18 is a phase change-type recording layer, it is preferred that the layer comprises a phase change-type optical recording material containing Ag, Al, In, Te, or Sb, which can be converted to at least two stages of the crystalline state and the amorphous state. Specific examples of such optical recording materials include Sb—Te alloys, Ge—Sb—Te alloys, Pd—Ge—Sb—Te alloys, Nb—Ge—Sb—Te alloys, Pd—Nb—Ge—Sb—Te alloys, Pt—Ge—Sb—Te alloys, Co—Ge—Sb—Te alloys, In—Sb—Te alloys, Ag—In—Sb—Te alloys, Ag—V—In—Sb—Te alloys, and Ag—Ge—In—Sb—Te alloys. Among them, the Ge—Sb—Te alloys and Ag—In—Sb—Te alloys are capable of rewriting many times, and thus are preferably used. The thickness of the phase change-type data recording layer 18 is preferably 10 to 50 nm, more preferably 15 to 30 nm.

The phase change-type data recording layer 18 may be formed by a gas-phase film deposition method such as a sputtering method or a vacuum vapor deposition method. A known dielectric layer may be formed on the data recording layer 18 if necessary.

### (Visible Information Recording Layer 24)

As described above, the optical recording medium 10 contains the visible information recording layer 24, which is closer to the second substrate 22 (or the cover layer) than the data recording layer 18. Desired visible information (image, character, etc.) such as a character, figure, or picture is recorded on the visible information recording layer 24. The visible information is an image that can be visually detected, and may contain any information such as a character (text), picture, or figure.

The visible information recorded on the visible information recording layer 24 may contain desired information such as a character, figure, or picture. Specifically, the visible information may contain a disc title, content information, a thumbnail of contents, a related picture, a design picture, a copyright notice, a recording date, a recording method, a recording format, a bar code, etc.

Further, the visible information may contain character information such as accessible personal information, accessible period information, accessible number information, rental information, resolution information, layer information, user designation information, copyright holder information, copyright number information, manufacturer information, manufacturing date information, sale date information, vendor or seller information, set number information, regional designation information, language designation information, use designation information, user information, or use number information.

The visible information recording layer 24 is not particularly limited as long as image information such as a character, image, or picture can be recorded thereon by irradiation of a laser light and visually confirmed. It is preferred that the visible information recording layer 24 contains a dye compound from the viewpoint of forming clear visible information by the irradiation of a laser light. The dye compound for the visible information recording layer 24 is preferably selected from the above described examples of the dyes for the data recording layer 18. It is preferred from the viewpoint of costs that the visible information recording layer 24 is formed by applying a coating liquid containing the dye compound by spin coating.

In the optical recording medium 10, the component (the dye or the phase change recording material) of the data recording layer 18 may be the same as or different from the component of the visible information recording layer 24. Because the desired functions are different between the data recording layer 18 and the visible information recording layer 24, the components thereof are preferably different. Specifically, it is preferred that the data recording layer 18 comprises a component excellent in recording/reproducing properties, and the visible information recording layer 24 comprises a component capable of forming a high-contrast image. In the case of using the dye, it is particularly preferred that the visible information recording layer 24 comprises a cyanine dye, a phthalocyanine dye, an azo dye, an azo metal complex, or an oxonol dye from the viewpoint of increasing the contrast of the recorded image.

The visible information recording layer 24 may comprise a leuco dye. Specifically, preferred examples of the leuco dyes include crystal violet lactones; phthalide compounds such as 3,3-bis(1-ethyl-2-methylindol-3-yl)phthalide and 3-(4-diethylamino-2-ethoxyphenyl)-3-(1-ethyl-2-methylindol-3-yl)-4-azaphthalide; and fluoran compounds such as 3-cyclohexylmethylamino-6-methyl-7-anilinofluoran, 2-(2-chloroanilino)-6-dibutylaminofluoran, 3-diethylamino-6-methyl-7-anilinofluoran, 3-diethylamino-6-methyl-7-xylidinofluoran, 2-(2-chloroanilino)-6-diethylaminofluoran, 2-anilino-3-methyl-6(N-ethylisopentylamino)fluoran, 3-diethylamino-6-chloro-7-anilinofluoran, 3-benzylethylamino-6-methyl-7-anilinofluoran, and 3-methylpropylamino-6-methyl-7-anilinofluoran.

The visible information recording layer 24 may be formed by dissolving the dye in a solvent to prepare a coating liquid, and by applying the coating liquid. The solvent may be the same as that of the coating liquid for the data recording layer 18. Additives and application methods for the visible information recording layer 24 are the same as those for the data recording layer 18.

The thickness of the visible information recording layer 24 is preferably 0.01 to 50 μm, more preferably 0.02 to 20 μm, further preferably 0.03 to 5 μm.

It is preferred that the visible information is recorded on the visible information recording layer 24 by repeatedly moving a laser light having a predetermined power along approximately the same path. Further, it is preferred that the laser light having a predetermined power is oscillated in the radius direction of the optical recording medium and moved repeatedly along approximately the same path.

### (First Substrate 16)

The first substrate 16 may comprise a material selected from materials used in conventional optical recording medium substrates.

Examples of the materials for the first substrate 16 include glasses, polycarbonates, acrylic resins such as polymethyl methacrylates, vinyl chloride resins such as polyvinyl chlorides and vinyl chloride copolymers, epoxy resins, amorphous polyolefins, and polyesters. These materials may be used in combination. The materials may be used in the state of a film or a rigid substrate as the first substrate 16. Among the materials, the polycarbonates are preferred from the viewpoints of humidity resistance, dimensional stability, and cost.

The thickness of the first substrate 16 is preferably 0.05 to 1.2 mm, more preferably 0.1 to 1.1 mm.

Guide grooves for tracking or concavities (pregrooves) with information of address signal, etc. are formed in the first substrate 16.

In a case where the optical recording medium is a DVD-R or DVD-RW, the track pitch of the pregrooves is preferably 300 to 900 nm, more preferably 350 to 850 nm, further preferably 400 to 800 nm.

The depth (the groove depth) of each pregroove is preferably 100 to 160 nm, more preferably 120 to 150 nm, further preferably 130 to 140 nm. The groove width (the half width) of each pregroove is preferably 200 to 400 nm, more preferably 230 to 380 nm, further preferably 250 to 350 nm.

The first substrate 16 may have grooves with a track pitch smaller than those of conventional DVD-Rs, to achieve a higher recording density. In this case, the track pitch of the grooves is preferably 280 to 450 nm, more preferably 300 to 420 nm, further preferably 320 to 400 nm. The depth (the groove depth) of each groove is preferably 15 to 150 nm, more preferably 25 to 100 nm. The groove width of each groove is preferably 50 to 250 nm, more preferably 100 to 200 nm.

In a case where the optical recording medium is a CD-R, the track pitch of the grooves is preferably 1.2 to 2.0 μm, more preferably 1.4 to 1.8 μm, further preferably 1.55 to 1.65 μm. The depth (the groove depth) of each groove is preferably 100 to 250 nm, more preferably 150 to 230 nm, further preferably 170 to 210 nm. The groove width of each groove is preferably 400 to 650 nm, more preferably 480 to 600 nm, further preferably 500 to 580 nm.

An undercoat layer may be formed on the grooved surface of the first substrate 16, on which the data recording layer 18 is formed, to improve flatness and adhesion and to prevent deterioration of the recording layer.

Examples of materials of the undercoat layer include polymers such as polymethyl methacrylates, acrylic acid-methacrylic acid copolymers, styrene-maleic anhydride copolymers, polyvinyl alcohols, N-methylolacrylamides, styrene-vinyltoluene copolymers, chlorosulfonated polyethylenes, nitrocelluloses, polyvinyl chlorides, chlorinated polyolefins, polyesters, polyimides, vinyl acetate-vinyl chloride copolymers, ethylene-vinyl acetate copolymers, polyethylenes, polypropylenes, and polycarbonates, and surface modifying agents such as silane coupling agents. The undercoat layer may be formed by dissolving or dispersing the material in an appropriate solvent, and by applying thus-obtained coating liquid to the substrate by a coating method such as spin coating, dip coating, or extrusion coating. The thickness of the undercoat layer is generally 0.005 to 20 μm, preferably 0.01 to 10 μM.

### (First Reflective Layer 20 and Second Reflective Layer 26)

The first reflective layer 20 and the second reflective layer 26 are preferably formed on the data recording layer 18 and the visible information recording layer 24 to increase the reflectance to the laser light for information reproduction. The first reflective layer 20 and the second reflective layer 26 preferably comprise a light reflective substance having a high reflectance to the laser light. Examples of the light reflective substances include metals of Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn, Bi, etc., metalloids, stainless steels, and semiconductor materials. These substances may be used singly or in combination, or as an alloy.

Among them, the light reflective substance is preferably Cr, Ni, Pt, Cu, Ag, Au, Al, or a stainless steel, particularly preferably Au, Ag, Al, or an alloy thereof, most preferably an Ag alloy such as an Ag—Nd—Cu alloy or an Ag—Pd—Cu alloy.

For example, the first reflective layer 20 and the second reflective layer 26 can be formed on the data recording layer 18 and the second substrate 22 by vapor-depositing, sputtering, or ion-plating the light reflective substance. The thickness of each of the first reflective layer 20 and the second reflective layer 26 is generally 10 to 300 nm, preferably 50 to 200 nm.

### (Adhesion Layer 28)

The adhesion layer 28 is formed to bond the first stack 12 containing the first substrate 16 to the second stack 14 containing the second substrate 22 in production of a bond type optical recording medium such as a DVD. The adhesion layer 28 is preferably composed of a light curing resin. It is preferred that the light curing resin has a small cure shrinkage ratio from the viewpoint of preventing warping of the resultant disc. Examples of such light curing resins include SD-640 and SD-661 available from Dainippon Ink and Chemicals, Inc., and SK6100, SK6300, and SK6400 available from Sony Chemical Corporation. The thickness of the adhesion layer 28 is preferably 1 to 100 μm, more preferably 5 to 60 μm, particularly preferably 20 to 55 μm, in view of flexibility.

### (Protective Layer, not Shown)

The protective layer is optionally formed to prevent penetration of water and scratching. The protective layer preferably comprises a UV curing resin, a visible light curing resin, a thermosetting resin, or silicon dioxide, particularly preferably comprises a UV curing resin. For example, SD-640 available from Dainippon Ink and Chemicals, Inc. can be used as the UV curing resin. Further, SD-347 and SD-694 available from Dainippon Ink and Chemicals, Inc., and SKCD1051 available from SKC can be used in the protective layer. The thickness of protective layer is preferably 1 to 200 μm, more preferably 50 to 150 μm.

### (Second Substrate 22)

The step of roughening the second substrate 22 is described in detail above, and thus duplicate explanations therefor are omitted.

The second substrate 22 having the roughened substrate surface 30 faces the first substrate 16 in the bond type optical recording medium 10. The second substrate 22 may comprise the same material as the first substrate 16. It is not necessary to form a groove on the surface of the second substrate 22, on which the visible information recording layer 24 is formed, as with the first substrate 16. The thickness of the second substrate 22 is preferably 0.05 to 1.2 mm, more preferably 0.1 to 1.1 mm, further preferably 0.5 to 0.7 mm.

In a case where the second substrate 22 is the cover layer, generally the cover layer is formed to physically and chemically protect the data recording layer 18, the visible information recording layer 24, etc. In this embodiment, the cover layer on the visible information recording layer 24 is roughened to increase the visibility of the visible information. The cover layer preferably has a thickness of 10 nm to 5 μm.

A transparent sheet of a polycarbonate or cellulose triacetate may be used as the cover layer. In this case, the transparent sheet preferably has a thickness of 0.01 to 0.2 mm. It is preferred that a surface of the transparent sheet, facing the visible information recording layer 24, is roughened by the stamper.

As described above, at least the visible information recording layer 24 and the data recording layer 18 are disposed in this order on one surface of the roughened second substrate 22 in the optical recording medium 10.

The second substrate 22 can be used in an optical member having a visible information recording layer 24 on which visible information is formed by a light, other than the optical recording medium 10. Thus, in the optical member, at least the visible information recording layer 24 is formed on the roughened surface of the substrate. Examples of such optical members include stickers.

In the optical recording medium 10 of this embodiment, an intermediate layer adjacent to the second substrate 22 may have a roughened surface facing the visible information recording layer 24. When the intermediate layer has the roughened surface facing the visible information recording layer 24, it is not necessary to form the roughened substrate surface 30 on the second substrate 22. The intermediate layer may be the protective layer, which may comprise a UV curing resin.

### Recording Method:

Specifically, visible information is recorded on the visible information recording layer 24 in the optical recording medium 10 of the embodiment by using an optical recording medium 10 according to the present embodiment and at least a recording apparatus capable of recording visible information on the visible information recording layer 24 of the optical recording medium 10.

In this embodiment, by using only one optical recording medium drive (a recording apparatus), visible information can be recorded on the visible information recording layer 24 and optical information can be recorded on the data recording layer 18. In the case of using only one optical recording medium drive, for example information is recorded on one of the visible information recording layer 24 and the data recording layer 18, the optical recording medium 10 is reversed, and then another information is recorded on the other layer. Examples of such optical recording medium drives having a function of recording a visible information on the visible information recording layer 24 are described in Japanese Laid-Open Patent Publication Nos. 2002-203321, 2003-203348, and 2003-242750, etc.

In this embodiment, by detecting the pre-pits 34, the presence of the visible information recording layer 24 in the optical recording medium 10 can be easily detected. Further, based on the information of the pre-pits 34, visible information can be recorded on the visible information recording layer 24 under an optimum laser output with excellent imaging properties. The combination of the pre-pits 34 may provide manufacturer information, etc.

It should be noted that the stamper producing method, the stamper for an optical recording medium, the substrate producing method, the substrate, the optical recording medium producing method, the optical recording medium, and the stamper producing apparatus according to the present invention are not limited to the above embodiment, and various changes and modifications may be made therein without departing from the scope of the present invention.

What is claimed is:

1. A method of producing a stamper for roughening a substrate of an optical recording medium, comprising:
a pit forming step of forming a pit forming site on a part of a major surface of a metal plate, said pit forming site being used for forming a pre-pit on said optical recording medium;
a masking step of placing a mask on said major surface, said mask being used for protecting said pit forming site; and
a blasting step of entirely or partly roughening said major surface by a blasting treatment to produce an original stamper.

2. A method of producing a stamper according to claim 1, wherein said masking step is carried out using a mask placing apparatus comprising a base, a supporting plate, first positioning means for positioning said supporting plate on said base, second positioning means for positioning said metal plate on said supporting plate, and an arm that is moved at least toward said supporting plate positioned on said base with said mask held by said arm, to place said mask on said pit forming site of said metal plate positioned on said supporting plate.

3. A method of producing a stamper according to claim 2, wherein said first positioning means comprises a concave portion or a convex portion formed on a surface of said supporting plate, said surface facing said base, and a convex portion or a concave portion formed on said base and to be fitted to said concave portion or said convex portion on said supporting plate, and
wherein a center of said concave portion or said convex portion of said supporting plate, a center of said convex portion or said concave portion of said base, and a center of said mask held by said arm are aligned with a vertical line.

4. A method of producing a stamper according to claim 2, wherein said mask is held by said arm by vacuum suction.

5. A method of producing a stamper according to claim 2, wherein said second positioning means comprises:
an alignment mark formed on a surface of said supporting plate, on which said metal plate is placed;
an imaging device for taking a first image of said alignment mark and a second image of said pit forming site of said metal plate placed on said supporting plate,
calculating means for calculating a first center determined by said alignment mark based on said first image taken with said imaging device and calculating a second center of said pit forming site based on said second image; and
correcting means for correcting a position of said metal plate on said supporting plate such that said second center corresponds to said first center.

6. A method of producing a stamper according to claim 5, wherein said second center substantially corresponds to said center of said concave portion or said convex portion of said supporting plate.

7. A method of producing a stamper according to claim 1, further comprising:
a washing step of detaching said mask from said original stamper and then washing said original stamper; and
a duplicating step of electroforming a metal layer on a surface of said original stamper, on which said pit forming site is formed, to produce a second-generation stamper comprising said metal layer.

8. A method of producing a substrate for an optical recording medium having a visible information recording layer, on which visible information is recorded, comprising
a stamper producing step of producing a stamper having an entirely or partly roughened major surface; and
a substrate producing step of using said stamper to produce said substrate having an entirely or partly roughened major surface, wherein
said stamper producing step comprises
a pit forming step of forming a pit forming site on a part of a major surface of a metal plate, said pit forming site being used for forming a pre-pit on said optical recording medium,
a masking step of placing a mask on said major surface, said mask being used for protecting said pit forming site, and
a blasting step of entirely or partly roughening said major surface by a blasting treatment to produce an original stamper.

9. A method of producing an optical recording medium having a substrate and a visible information recording layer formed thereon, on which visible information is recorded, comprising:
a stamper producing step of producing a stamper having an entirely or partly roughened major surface;
a substrate producing step of using said stamper to produce said substrate having an entirely or partly roughened major surface; and
a visible information recording layer forming step of forming said visible information recording layer on said substrate, wherein
said stamper producing step comprises
a pit forming step of forming a pit forming site on a part of a major surface of a metal plate, said pit forming site being used for forming a pre-pit on said optical recording medium,
a masking step of placing a mask on said major surface, said mask being used for protecting said pit forming site; and
a blasting step of entirely or partly roughening said major surface by a blasting treatment to produce an original stamper.

10. An apparatus for producing a stamper for roughening a substrate of an optical recording medium, comprising:
a base;
a supporting plate;
first positioning means for positioning said supporting plate on said base;
second positioning means for positioning a metal plate on said supporting plate; and
an arm that is moved at least toward said supporting plate positioned on said base with a mask held by said arm, to place said mask on a pit forming site of said metal plate positioned on said supporting plate.

11. An apparatus for producing a stamper according to claim 10, wherein said first positioning means comprises a concave portion or a convex portion formed on a surface of said supporting plate, said surface facing said base, and a convex portion or a concave portion formed on said base and to be fitted to said concave portion or said convex portion on said supporting plate, and
a center of said concave portion or said convex portion of said supporting plate, a center of said convex portion or said concave portion of said base, and a center of said mask held by said arm are aligned with a vertical line.

12. An apparatus for producing a stamper according to claim 10, wherein said mask is held by said arm by vacuum suction.

13. An apparatus for producing a stamper according to claim 10, wherein said second positioning means comprises:
an alignment mark formed on a surface of said supporting plate, on which said metal plate is placed;
an imaging device for taking a first image of said alignment mark and a second image of said pit forming site of said metal plate placed on said supporting plate;
calculating means for calculating a first center of said supporting plate determined by said alignment mark based on said first image taken with said imaging device and calculating a second center of said pit forming site based on said second image; and
correcting means for correcting a position of said metal plate on said supporting plate such that said second center corresponds to said first center.

14. An apparatus for producing a stamper according to claim 13, wherein said first center substantially corresponds to said center of said concave portion or said convex portion of said supporting plate.
